(19) United States
(12) Patent Application Publication
(10) Pub. No.: US 2012/0188384 A1
(43) Pub. Date: Jul. 26, 2012

(54) RECORDING APPARATUS

(75) Inventors: TSUTOMU MUKAI, Osaka (JP); SOWYO MATSUMURA, Osaka (JP); SHIGEO SAKAUE, Osaka (JP)

(73) Assignee: PANASONIC CORPORATION, Osaka (JP)

(21) Appl. No.: 13/355,636

(22) Filed: Jan. 23, 2012

(30) Foreign Application Priority Data
Jan. 24, 2011 (JP) 2011-011668

(51) Int. Cl. H04N 5/225; G06F 12/00

(52) U.S. Cl. 348/207.99; 711/115; 711/E12.001; 348/E05.024

(57) ABSTRACT

A recording apparatus includes a medium mounting unit operable to mount a removable recording medium which stores data, a storage unit operable to store an uploader for providing a function of uploading data to an external server via a network, the uploader being software executed by an external apparatus, and a recording controller operable to record, in the recording medium, list information for specifying data to be uploaded to the external server out of data stored in the recording medium, and the uploader stored in the storage unit.

### BACKGROUND

1. Technical Field

The technical field relates to a recording apparatus for recording data in a recording medium.

2. Related Art

A technique that uploads image data recorded in a recording medium onto an external server is generally known. For example, JP2002-218359A discloses a technique for uploading image data stored in a recording medium (a memory card or the like) via a network by user connecting the recording medium to a terminal device disposed in a shop and operating keys displayed on a screen of the terminal device.

Even in an environment in which access to an external server is enabled, if a terminal device does not have an uploader as application for uploading image data, the terminal device cannot upload the image data. In this case, a user cannot upload desired image data from the terminal device onto the external server, resulting in inconvenience of the user.

### SUMMARY

To solve the above problem, a recording apparatus is provided that enables upload of image data in a terminal device even when the terminal device (an external apparatus) does not have a function for uploading image data.

In a first aspect, a recording apparatus is provided, which includes a medium mounting unit operable to mount a removable recording medium which stores data, a storage unit operable to store an uploader for providing a function of uploading data to an external server via a network, the uploader being software executed by an external apparatus, and a recording controller operable to record, in the recording medium, list information for specifying data to be uploaded to the external server out of data stored in the recording medium, and the uploader stored in the storage unit.

In a second aspect, an imaging apparatus includes a medium mounting unit operable to mount a removable recording medium which stores data, a storage unit operable to store an uploader for providing a function of uploading data to an external server via a network, the uploader being software executed by an external apparatus, and a recording controller operable to record, in the recording medium, list information for specifying data to be uploaded to the external server out of data stored in the recording medium, and the uploader stored in the storage unit.

According to the above aspects, even when the terminal device (external apparatus) cannot perform a function for uploading data, the terminal device performs the uploader stored in the recording medium to realize the upload function. Accordingly, the convenience for users for uploading data can be improved.

### BRIEF DESCRIPTION OF DRAWINGS

FIG. 1 is a front view of a digital camera.

FIG. 2 is a rear view of the digital camera.

FIG. 3 is a block diagram illustrating a configuration of the digital camera.

FIG. 4 is a block diagram illustrating a configuration of a personal computer (PC).

FIG. 5 is a diagram describing data transfer with USB cable connection.

FIG. 6 is a diagram explaining data transfer via a memory card.

FIG. 7 is a flowchart illustrating a writing operation in the digital camera.

FIG. 8 is a diagram explaining an example of a screen for selecting image data to be uploaded displayed on the digital camera.

FIG. 9 is a diagram showing information to be stored in the memory card.

FIG. 10A is a flowchart of an upload operation in the personal computer (PC).

FIG. 10B is a diagram describing an example of an image showing candidates of actions to a memory card, which is displayed upon insertion of the memory card into PC.

FIG. 10C is a diagram describing an example of an image (upload screen) for selecting upload service (upload destination) which is displayed on the PC.

FIG. 11 is a diagram describing a mark added to image data which has been uploaded.

FIG. 12 is a diagram describing a use case in which upload is carried out with the digital camera and the PC connected via a USB cable.

FIG. 13 is a diagram describing a use case in which upload is carried out with the digital camera and the PC connected via the USB cable.

FIG. 14 is a diagram describing a use case in which the upload function is realized by an uploader stored in the memory card.

FIG. 15 is a diagram describing thumbnail images relating to moving image data recorded in the memory card.

### DETAILED DESCRIPTION OF PREFERRED EMBODIMENTS

Preferred embodiments are described below with reference to the attached acccompanying drawings.

### First Embodiment

A digital camera according to a first embodiment records an uploader and list information (an upload list) to a memory card (a recording medium) for storing image data. The uploader can be software performed by a personal computer, and realizes a function for uploading data onto an external server via a network. The list information is for specifying data in data stored in the memory card to be uploaded to the external server. When the memory card in which the uploader and the list information are recorded is inserted into the personal computer, the personal computer can realize an upload function by running the uploader recorded in the memory card even if the personal computer does not have the upload function.

Configurations and operations of the digital camera and the personal computer according to the first embodiment are described in detail below with reference to the drawings.

### 1. Configuration

### 1-1. Configuration of Digital Camera

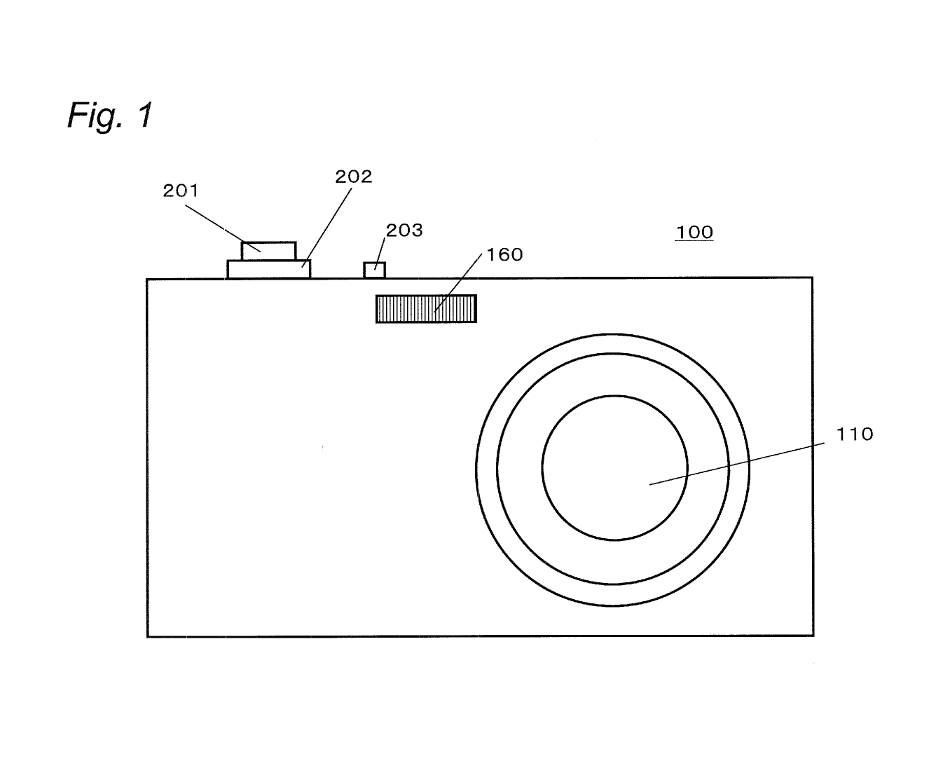

FIG. 1 is a front view of an exemplary digital camera 100 according to an exemplary embodiment. The digital camera 100 has, at the front face thereof, a lens barrel that contains an optical system 110, and a flash 160. In addition, the digital camera 100 has, at the top face thereof, operation buttons such as a release button 201, a zoom lever 202, and a power supply 203.

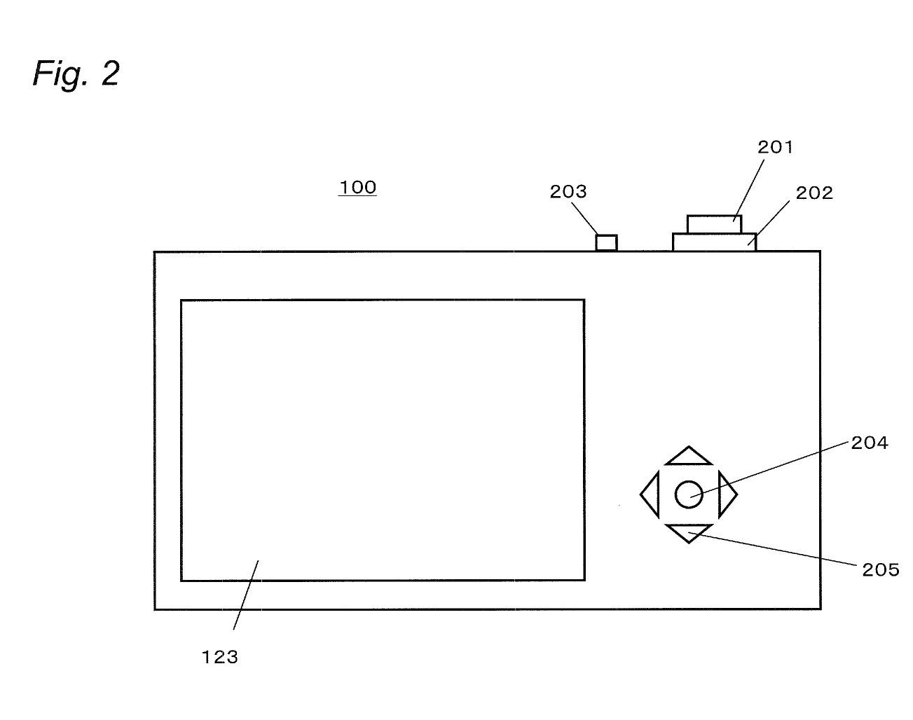

FIG. 2 is a back view of the digital camera 100. The digital camera 100 has, at the back face thereof, a liquid crystal display (LCD) monitor 123 and operating buttons such as a center button 204, and a cross button 205.

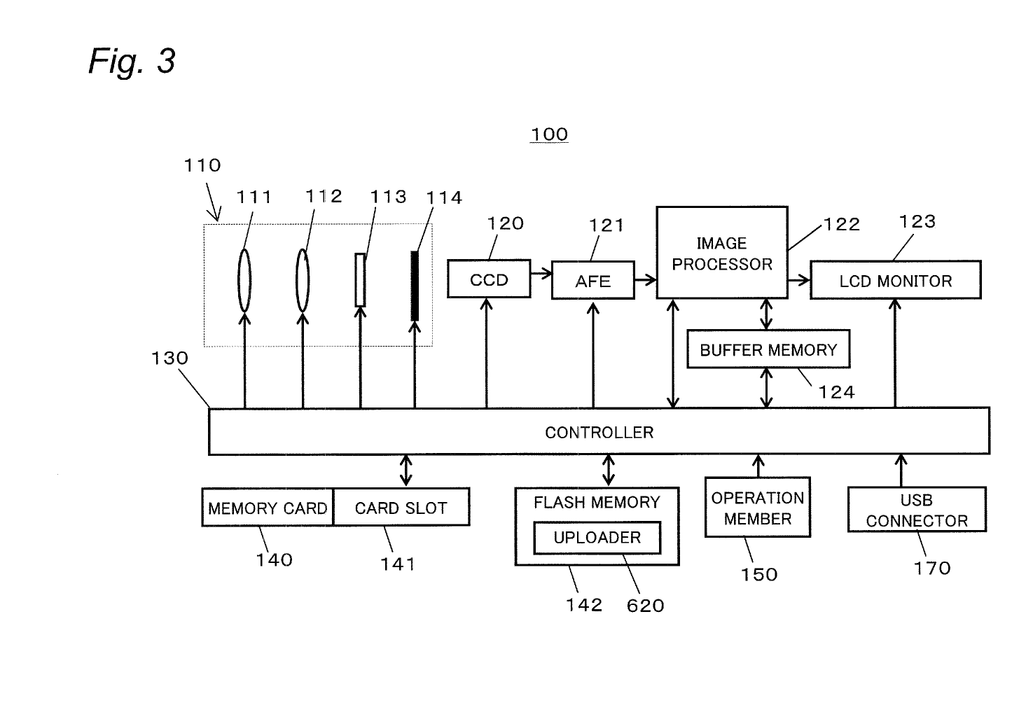

FIG. 3 is an electrical configuration diagram of the digital camera 100. The digital camera 100 captures, with a CCD image sensor 120, a subject image formed through the optical system 110. The CCD image sensor 120 generates image information based on the captured subject image. The image information generated by the CCD image sensor 120 is subjected to various processes in an AFE (Analog Front End) 121 and an image processor 122. The image information subjected to various processes is recorded in a flash memory 142 or a memory card 140. The image information recorded in the flash memory 142 or the memory card 140 is displayed on the liquid crystal display monitor 123 according to an operation performed on an operation unit 150 by a user. Details of the configurations shown in FIGS. 1 to 3 will be described below.

The optical system 110 includes a focus lens 111, a zoom lens 112, a diaphragm 113, a shutter 114, and the like. The optical system 110 may include an optical camera shake correction lens (OIS: Optical Image Stabilizer) (not shown). Each of lenses included in the optical system 110 may be realized in any number of lenses or any number of lens groups.

The CCD image sensor 120 captures a subject image formed through the optical system 110 and generates image information. The CCD image sensor 120 generates a new frame of image data in a predetermined frame rate (for example, 30 frames/sec). A timing of generating image data and an electronic shutter operation of the CCD image sensor 120 are controlled by the controller 130. The generated image data is sequentially displayed on the LCD monitor 123 so that a user can check a status of an object in real time on the LCD monitor 123.

The AFE 121 performs noise suppression with correlated double sampling, gain multiplication based on an ISO sensitivity with an analog gain controller, and AD conversion with an AD converter, on the image information inputted from the CCD image sensor 120. Thereafter, the AFE 121 outputs the image information to the image processor 122.

The image processor 122 performs various processes on the image information outputted from the AFE 121. The various processes include, for example, adding up of BMs (block memories), smear correction, white balance correction, gamma correction, a YC conversion process, an electronic zoom process, a compression process, and a decompression process, but are not limited thereto. The image processor 122 may be composed of a hard-wired electronic circuit or a microcomputer using a program, etc. Alternatively, the image processor 122 may be made in a single semiconductor chip together with other functional units such as the controller 130.

The liquid crystal display (LCD) monitor 123 is provided on the back face of the digital camera 100. The liquid crystal display monitor 123 displays an image created based on the image information processed by the image processor 122. Images to be displayed on the liquid crystal display monitor 123 include a through image and a recorded image. The through image is an image obtained by continuously displaying frame images which are created every certain period of time by the CCD image sensor 120. Normally, when the digital camera 100 is in the recording mode, the image processor 122 creates a through image from image information generated by the CCD image sensor 120. By seeing a through image displayed on the liquid crystal display monitor 123, a user can shoot an image while checking a composition of an image. The recorded image is an image obtained by resiting a moving image of high pixel size or a still image of high pixel size recorded in the memory card 140, etc., to an image of low pixel size to display the image on the liquid crystal display monitor 123, when the digital camera 100 is in the playback mode.

The controller 130 controls the entire operation of the digital camera 100. The controller 130 may be composed of a hard-wired electronic circuit, a microcomputer, or the like. Alternatively, the controller 130 may be made in a single semiconductor chip together with the image processor 122, etc.

The flash memory 142 functions as an internal memory for recording image information and the like. In addition, the flash memory 142 stores therein programs for performing overall control of the entire operation of the digital camera 100, in addition to programs relating to autofocus control (AF control), automatic exposure control (AE control), and light emission control of the flash 160.

Particularly, in the digital camera 100 of the present embodiment, the flash memory 142 stores an uploader 620 which is a software for uploading image data to a server which provides a image storage service. The controller 130 can read the uploader 620 stored in the flash memory 142 and write it in the memory card 140 (The details are described later).

A buffer memory 124 is storage means that functions as a working memory for the image processor 122 and the controller 130. The buffer memory 124 can be realized by a DRAM (Dynamic Random Access Memory) and the like.

The card slot 141 is connection means that allows the memory card 140 to be inserted therein and removed therefrom. The card slot 141 allows the memory card 140 to be electrically and mechanically connected thereto. In addition, the card slot 141 may have a function of controlling the memory card 140.

The memory card 140 is an external memory including a storage device such as a flash memory. The memory card 140 can record data such as image information processed by the image processor 122.

The USB connector 170 is an interface for connecting to a USB connector of the other device via a USB cable. The controller 130 can communicate several kinds of data with the other device via the USB connector 170 and the USB cable.

The operation unit 150 is a collective term for operation buttons and an operation lever provided on the exterior of the digital camera 100, and receives operations performed by the user. The operation unit 150 includes, for example, the release button 201, the zoom lever 202, the power button 203, the center button 204, the cross button 205, and the moving image recording button 206 which are shown in FIGS. 1 and 2. Upon receipt of operations performed by the user, the operation unit 150 sends various operation command signals to the controller 130.

### 1-2. Configuration of Personal Computer

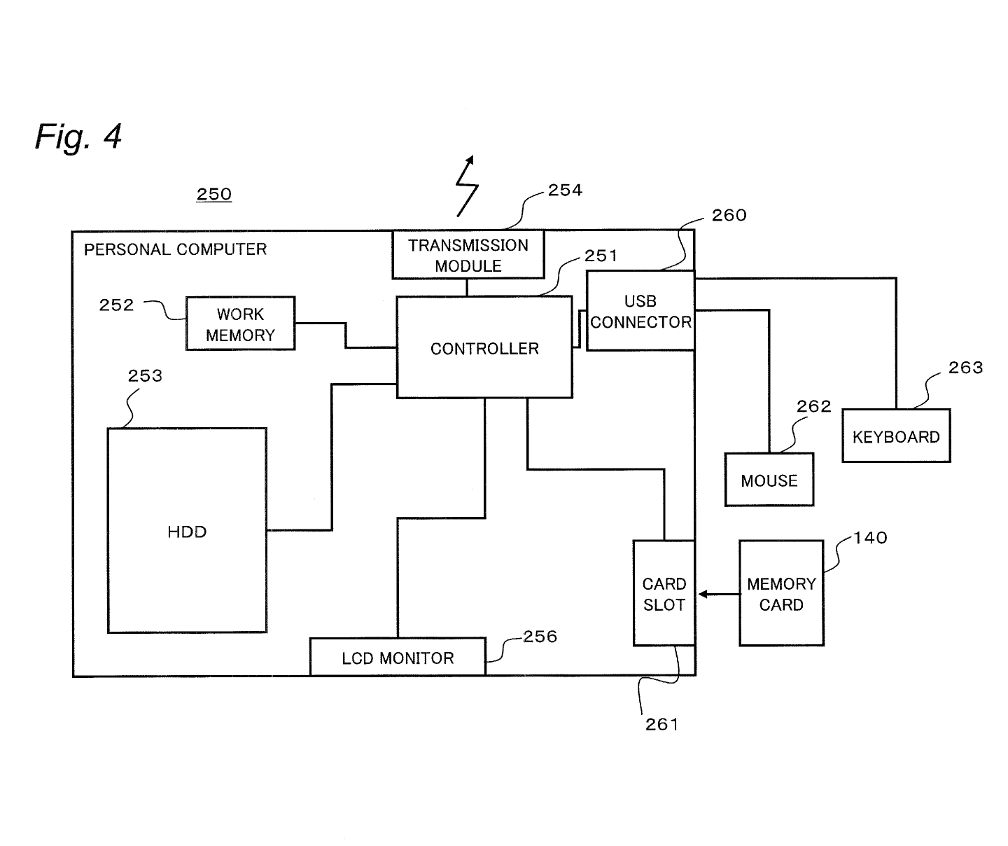

The configuration of a personal computer (hereinafter, referred to as “PC”) that receives data to be uploaded from a digital camera 100 according to the first embodiment via a memory card 140 is described below. FIG. 4 is a diagram illustrating the configuration of the personal computer.

A personal computer 250 includes a controller 251, a working memory 252, an HDD 253, a transmission module 254, a liquid crystal display monitor (LCD) monitor 256, a USB connector 260, a card slot 261, a mouse 262, a keyboard 263 and the like.

The controller 251 is a processing section for executing various processing on the PC 250. The controller 251 is electrically connected to the working memory 252, the HDD 253, the transmission module 254, the LCD monitor 256, the USB connector 260, the card slot 261, the mouse 262 and the keyboard 263. The controller 251 receives operation information about user's operations with the mouse 262 and the keyboard 263 via the USB connector 260. The controller 251 can read data stored in the HDD 253. Further, the controller 251 controls entire system including a control of power supplied to the respective sections of the PC 100.

The working memory 252 is a memory for temporarily storing information necessary for performing various processing of the controller 251.

The HDD 253 is a large-capacity disc drive for storing various data. The various data stored in the HDD 253 can be suitably read by the controller 251.

The mouse 262 is a pointing device that receives user's operations. The keyboard 263 is a device by which a user inputs characters or the like.

The USB connector 260 is an interface for connecting the PC 250 to another device with an USB connector of the other device and a USB cable. The controller 251 can transmit/receive information to/from the other device via the USB connector 260 and the USB cable. The USB connector 260 can be connected to the digital camera 100, the mouse 262, the keyboard 263 and the like that support USB interface.

The LCD monitor 256 is a display device for displaying a screen instructed by the controller 251.

The transmission module 254 can transmit image data received from the controller 251 to the other device via a network. The transmission module 254 can be realized by, for example, a wired LAN or a wireless LAN.

The card slot 261 is connecting means to which the memory card 140 is attachable. The card slot 261 can be electrically and mechanically connected to the memory card 140. Further, the card slot 261 may have a function of controlling the memory card 140. The controller 251 can read image data stored in the memory card 140 via the card slot 261. The controller 251 runs an uploader (described later) stored in the memory card 140 so as to cause the image data stored in the memory card 140 to be transmitted to another device (a server that provides image storage service) via the transmission module 254.

1-3. Data Transmission from Digital Camera to PC and Data Upload

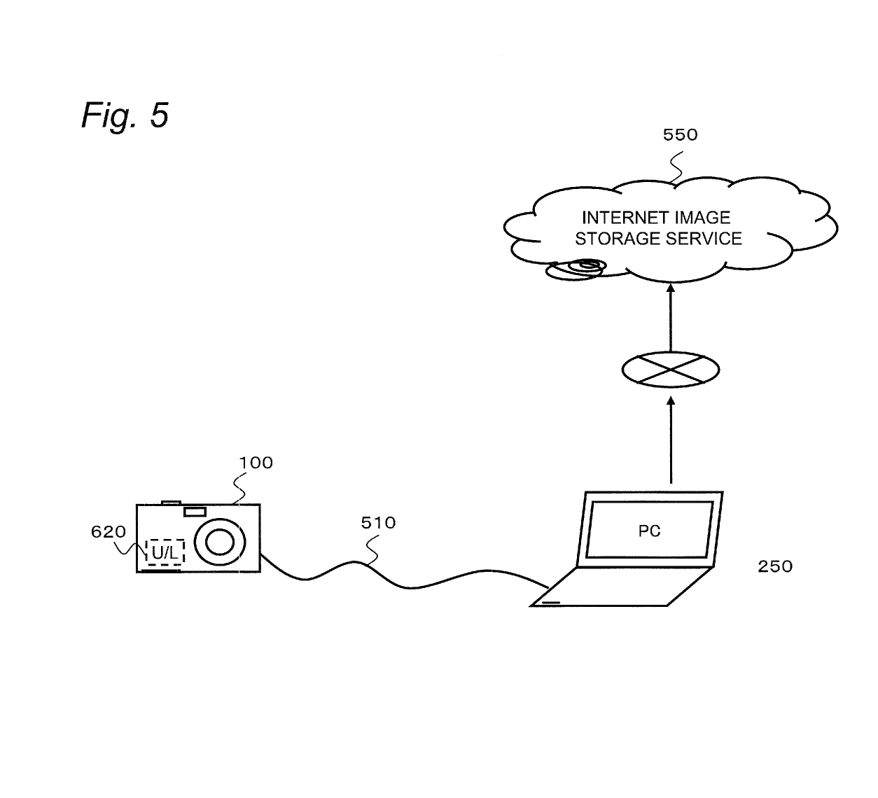

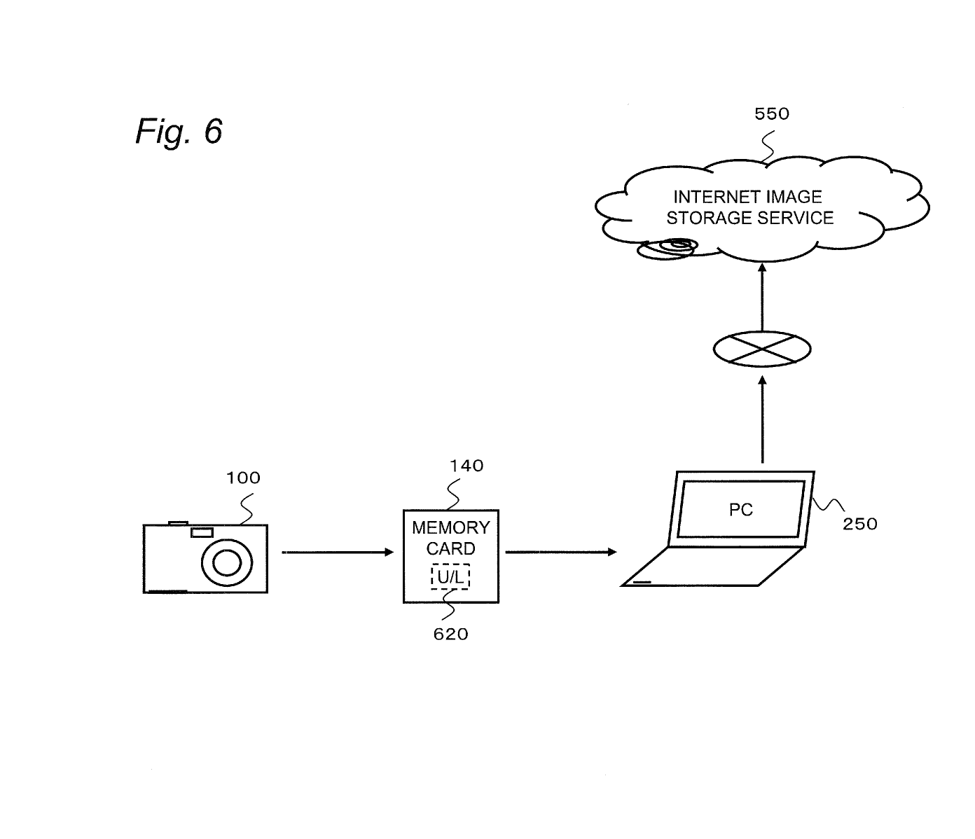

The data transmission from the digital camera 100 to the PC 250 and upload, which are realized by the digital camera 100 according to the first embodiment, are described. The methods for transmitting data from the digital camera 100 to the PC 250 include two methods shown in FIGS. 5 and 6. FIG. 5 is a diagram describing data transmission via the USB cable connection. FIG. 6 is a diagram describing data transmission with the memory card.

### 1-3-1. Data Transmission via USB Cable

Firstly, the data transmission and upload with the digital camera 100 and the PC 250 being connected via a USB cable 510 are described with reference to FIG. 5.

A controller 130 of the digital camera 100 can cause the controller 251 of the PC 250 to read image data to be uploaded via the USB cable 510. The controller 251 of the PC 250 can run an uploader (software for uploading image data to a server that provides image storage services) 620 stored in a flash memory 142 of the digital camera 100 via the USB cable 510. By running the uploader 620, controller 251 of the PC 250 can upload the image data to be uploaded to a server 550 that provides the image storage service.

According to such a method, the PC 250 can achieve the upload function though not having the uploader 620, by connecting the PC 250 to the digital camera 100 via the USB cable 510. The PC 250 may once record the image data and the uploader 620 received from the digital camera 100 to the HDD 253 and then execute the uploading process. As a result, it is not necessary to continuously connect the digital camera 100 and the PC 250 until completion of the upload.

1-3-2. Data Transmission with Memory Card

Execution of the data transmission and the upload via the memory card 140 is described below with reference to FIG. 6.

The controller 130 of the digital camera 100 records a plurality of shot image data including image data to be uploaded in the memory card 140. Further, the controller 130 records the uploader 620 as well as the image data to be uploaded, in the memory card 140.

The memory card 140 which stores the image data to be uploaded and the uploader 620 is inserted to the card slot 261 of the PC 250. The controller 251 of the PC 250 can read the image data from the inserted memory card 140. Further, the controller 251 of the PC 250 can run the uploader 620 recorded in the inserted memory card 140. The controller 251 of the PC 250 runs the uploader 620 to upload the image data to be uploaded that is recorded in the memory card 140 to the server 550 that provides the image storage service.

In such a method, the PC 250, though not having the uploader, can achieve the upload function by running the uploader 620 which is recorded in the memory card 140 by the digital camera 100.

The digital camera 100 according to the first embodiment can realize the upload function in the PC 250 even if the PC 250 does not have the uploader.

### 1-4. Term Correspondence

A card slot 141 is one example of a medium mounting unit. A flash memory 142 is one example of a storage unit. The memory card 140 is one example of a removable recording medium. The controller 130 is one example of a recording controller, a selecting unit, and a display controller. The digital camera 100 is one example of a recording apparatus and an imaging apparatus.

### 2. Operation

Operations of the digital camera 100 and the PC 250 according to the first embodiment are described below.

### 2-1. Operation of Digital Camera for Writing Data to be Uploaded

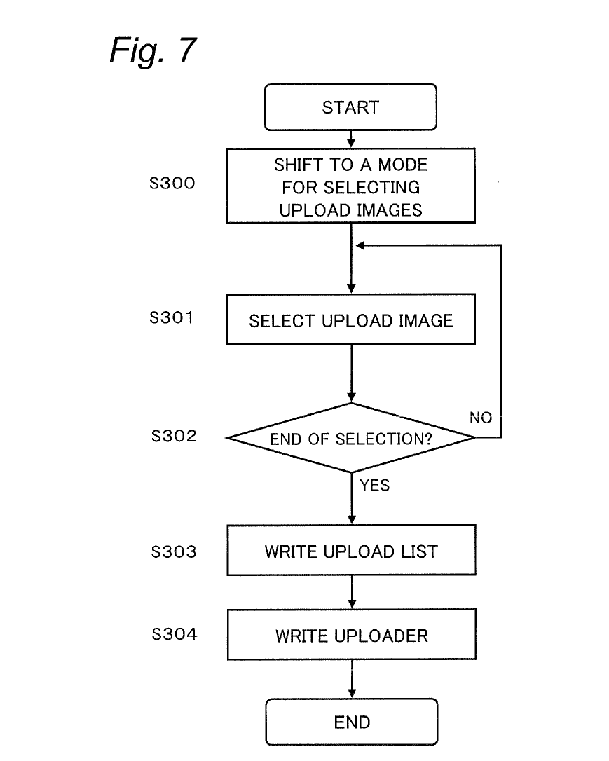

The operation for writing the data to be uploaded in the memory card 140 by the digital camera 100 is described first. FIG. 7 is a flowchart illustrating the operation for writing the data to be uploaded in the memory card 140 by the digital camera 100.

When the digital camera 100 is set to a playback mode by a user's operation of the predetermined operation unit 150, a list of thumbnails of image data recorded in the memory card 140 is displayed on a LCD monitor 123. At this time, when the digital camera 100 receives user's operation for changing the mode to a mode for selecting an upload image, the controller 130 changes the mode of the digital camera 100 into the mode for selecting an upload image (S300).

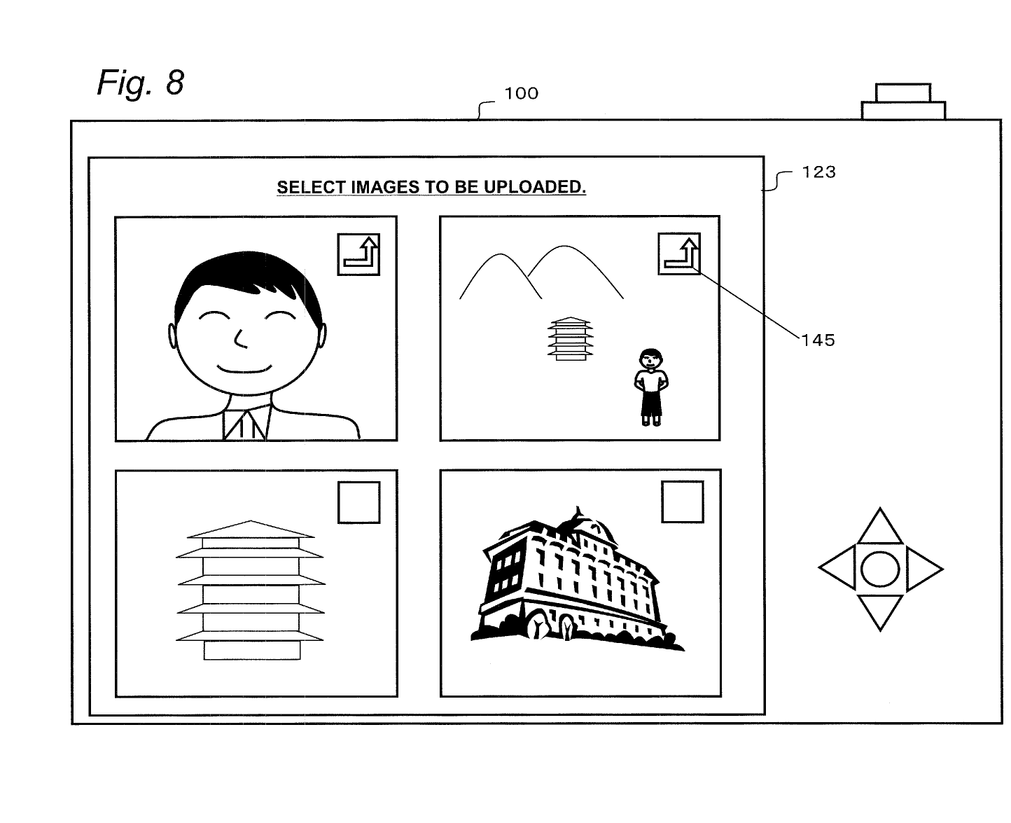

When the digital camera 100 is set to the mode for selecting an upload image, the LCD monitor 123 displays an image as shown in FIG. 8. FIG. 8 is a diagram describing a screen for selecting image data to be uploaded. As shown in FIG. 8, the LCD monitor 123 displays the thumbnail list of the image data recorded in the memory card 140, and further displays a message “Select images to be uploaded” that prompts the user to perform an operation for selection. While viewing the thumbnail list displayed on the LCD monitor 123, the user can select image data desired to be uploaded. The controller 130 selects the image data specified by the user as targets to be uploaded based on the user's operation of the predetermined operation unit 150 (for example, a center button 204 and a cross button 205) (S301). A mark 145 showing that image data with the mark is selected as target to be uploaded is displayed on an upper left part of the thumbnail image of the image data selected as the target to be uploaded by the user. The displaying of the mark 145 enables the user to know which image data in the thumbnail list image displayed on the LCD monitor 123 is the target to be uploaded.

The user presses down the predetermined operation unit 150 to end the selection of the images to be uploaded. The controller 130 monitors or determines whether the user ends the selection of the images to be uploaded (S302). When the user determines that the selection of the images to be uploaded is ended (YES at S302), the controller 130 creates a list of the image data to be uploaded (hereinafter, referred to as “upload list”), and writes the created list in the memory card 140 (S303). The upload list includes identification numbers for specifying the image data to be uploaded or the like.

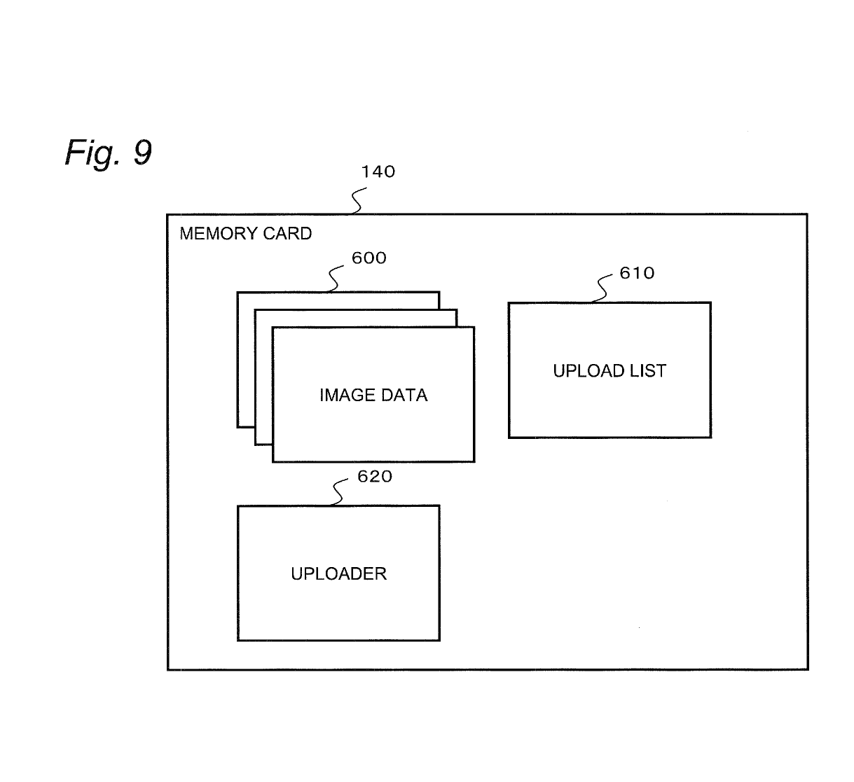

Thereafter, the controller 130 reads the uploader 620 (the software for upload) stored in the flash memory 142, and writes the uploader 620 in the memory card 140 (S304). At this time, information is recorded in the memory card 140 as shown in FIG. 9. As shown in FIG. 9, image data 600, the upload list 610 including the information for specifying image data to be uploaded, and the uploader 620 are recorded in the memory card 140.

When the selection of the images to be uploaded is ended, the controller 130 of the digital camera 100 writes the list of image data to be uploaded and the uploader 620 into the memory card 140.

### 2-2. Upload Operation of PC

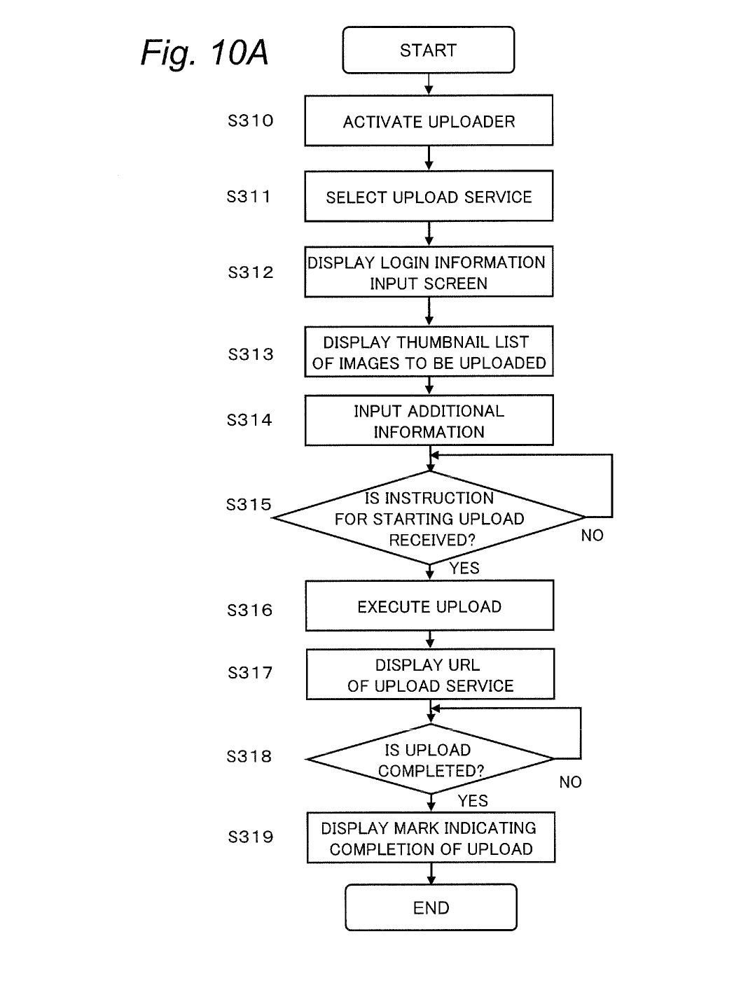

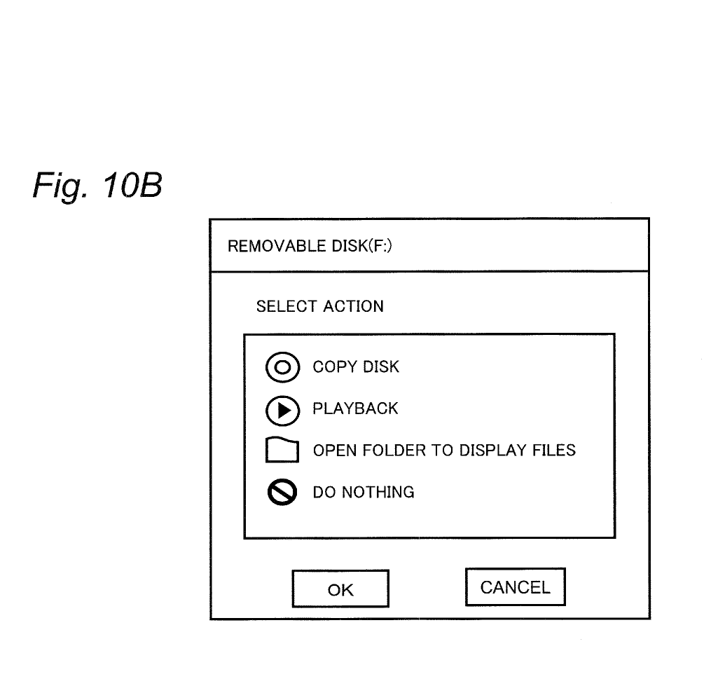

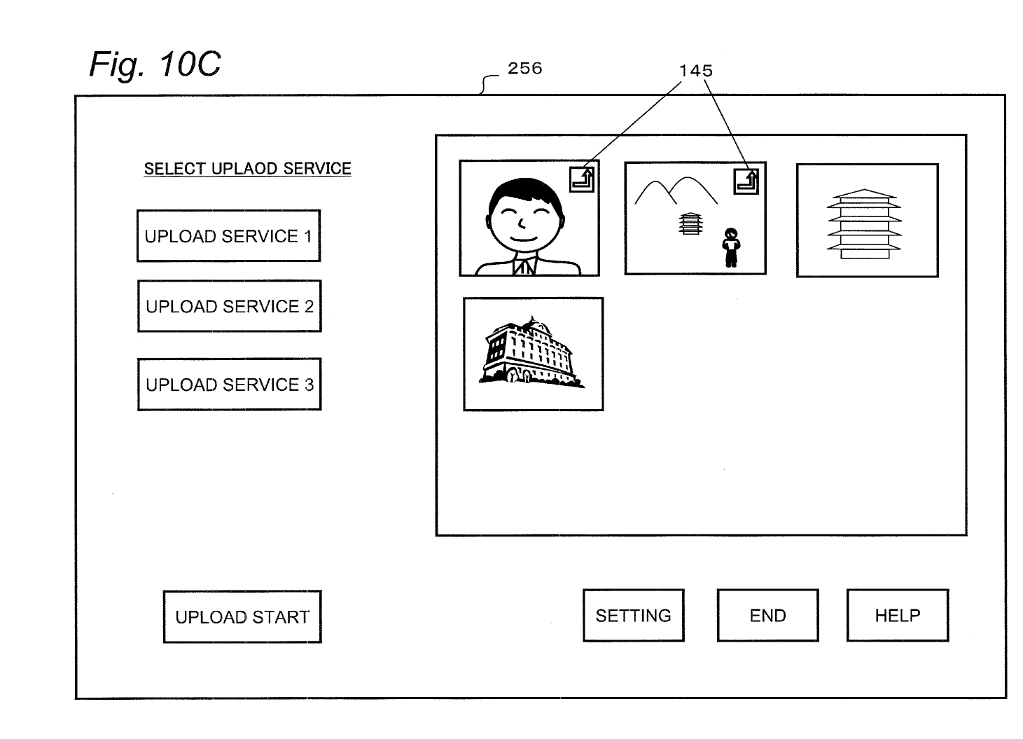

The operation of the PC 250 for uploading the image data selected by the digital camera 100 is described below. FIG. 10A is a flowchart illustrating the upload operation of the personal computer 250.

When the controller 251 of the PC 250 detects that the memory card 140 is inserted or mounted to the card slot 261, the controller 251 reads the data recorded in the memory card 140. At this time, when the upload list 610 is recorded in the memory card 140, the controller 251 activates the uploader 620 recorded in the memory card 140 (S310).

In the above example, the uploader 620 is automatically activated by the controller 251 of the PC 250, but it may be manually activated by the user operation. For example, when the memory card 140 is inserted in the card slot 261 of the PC 250, the controller 251 of the PC 250 may display a screen showing candidates of actions for the memory card, as shown in FIG. 10B. When the user opens a folder of the memory card 140 via that screen and makes an operation for running the uploader 620 (for example, clicks an icon of the uploader), the controller 251 of the PC 250 may activate the uploader 620 according to the user's operation.

When the uploader 620 starts, an upload screen as shown in FIG. 10C is displayed on the LCD monitor 256 of the PC 250. As shown in FIG. 10C, names of a plurality of image storage services (upload services) provided on the network are displayed on the upload screen. In the example of FIG. 10C, as the image storage services, the three service names including “upload service 1”, “upload service 2”, “upload service 3” are displayed so that one of them can be selected. As the site that provides the image storage service, for example, there are ‘Facebook’ and ‘YouTube’. Further, thumbnail images of all the image data stored in the memory card 140 are displayed on the upload screen. The controller 251 of the PC 250 displays, based on the upload list 610, the marks 145 on images that are selected in advance as images to be uploaded in the digital camera 100. The user can check the image to be uploaded with the mark 145. The controller 251 of the PC 250 may display the thumbnails of only the images that are selected in advance as images to be uploaded in the digital camera 100, on the upload screen.

In this embodiment, on the upload screen (see FIG. 10C) displayed on the PC 250, the user can set the images to be uploaded (select or cancel). For example, when the user clicks the mark 145 of the image selected as the image to be uploaded with the mouse 262, the controller 251 of the PC 250 eliminates the image from the images to be uploaded in the upload list 610. On the other hand, when the user clicks an image that is not selected as image to be uploaded, with the mouse 262, the controller 251 of the PC 250 adds the image as image to be uploaded in the upload list 610. In this manner, the setting for the image to be uploaded can be made in the PC 250, and the setting on the PC 250 is reflected on the upload list 610. Hence, the setting of the image to be uploaded that is changed on the PC 250 can be confirmed on the side of the digital camera 100.

The controller 251 selects the image storage service according to user's operation with the mouse 262, or the like (S311). When the image storage service is selected, the controller 251 displays an input screen for login information for logging in the selected image storage service on the LCD monitor 256 (S312). The login information includes a login ID and a password. When the user inputs the login information with the keyboard 263, the controller 251 transmits the login information to the site of the image storage service, making it possible to log in the image storage service. The digital camera 100 may record the login information about the image storage services in the memory card 140. In this case, the controller 251 does not display the input screen for the login information on the LCD monitor 256, and may read the login information from the memory card 140 to transmit the read login information to the site of the image storage service. Hence, user's time and effort for the input of the login information can be saved.

When logging in the image storage service, the controller 251 refers to the upload list 610 recorded in the memory card 140 to specify the images to be uploaded, and displays a thumbnail list of the images to be uploaded on the LCD monitor 256 (S313). The user can input additional information such as comments in the image data to be uploaded, as needed. When the additional information is input by the user, the controller 251 acquires the input additional information (S314).

The user can instruct the execution of the upload by pressing down a predetermined button displayed on the screen using the mouse 262 or the like. The controller 251 monitors whether the user instructs about the execution of the upload (S315). When the user instructs about the execution of the upload (YES at S315), the controller 251 specifies image data to be uploaded based on the upload list 610 and carries out upload of the specified image data (S316). At this time, the controller 251 makes a control according to the uploader (an application program for the upload) 620 recorded in the memory card 140 to execute the uploading process.

When the upload of the image data to be uploaded to the server of the image storage service is completed, the controller 251 acquires URL information about upload destination from the server to display the URL information on the LCD monitor 256 (S317). This display enables the user to recognize the URL information about the upload destination. The controller 251 writes information indicating completion of upload of the image data, in the upload list 610. At this time, a button for copying the displayed URL information may be displayed on the upload screen. Further, when the displayed URL information is clicked by the user, the site indicated by the URL information may be connected. Alternatively, a button for connecting to the site indicated by the URL information may be displayed on the upload screen.

The controller 251 monitors whether the user ends the image storage service (S318). When the image storage service is ended, the controller 251 displays the mark 145 representing that the upload of the uploaded image data is completed on the thumbnail image (S319).

In this manner, the PC 250 performs the upload operation on the image data selected from the image data recorded in the memory card 140.

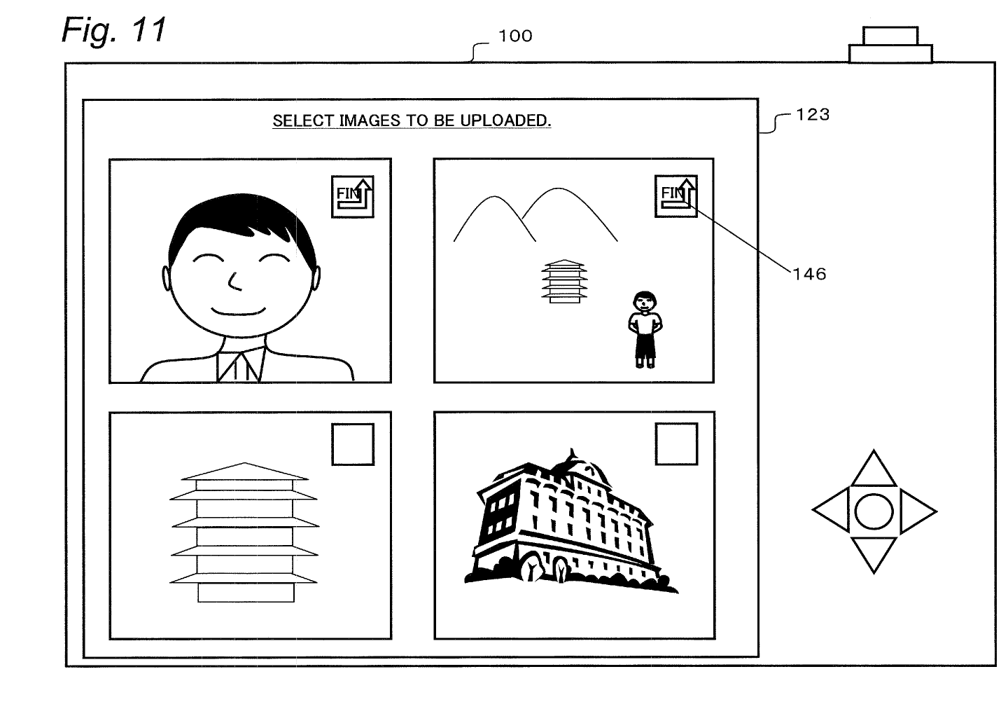

After the end of the upload by the PC 250, the memory card 140 is again inserted to the card slot 141 of the digital camera 100, when the selection screen of images to be uploaded or the image list display screen is opened, a mark 146 representing the completion of the upload is displayed on the thumbnail images of the uploaded image data, as shown in FIG. 11. At this time, by referring to the information indicating completion of upload that is written in the upload list 610 recorded in the memory card 140, the controller 130 of the digital camera 100 can identify image data which has been already uploaded. The mark 146 enables the user to recognize which image data in the list of thumbnail images displayed on the LCD monitor 123 has been already uploaded.

### 3. Use Cases and Conveniences Thereof

As described above, the method for transmitting data from the digital camera 100 to the PC 250 includes a transmission method with USB cable connection and a transmission method with the memory card. The use case and convenience of each method are described below.

In the following description, a case where a user A and a user B are present and image data recorded in a memory card owned by the user B is uploaded is assumed. User A's personal belongings are denoted by a reference sign added with the last character of “A”, such as a digital camera 100A, a USB cable 510A, and a PC 250A. Similarly, user B's personal belongings are denoted by a reference sign added with the last character of “B”, such as a digital camera 100B, the memory card 140B, and the PC 250B.

3.1 Case of Transmission with USB Cable Connection

The use case and convenience thereof where the data transmission is performed between the digital camera 100 and the PC 250 via the USE cable are described first.

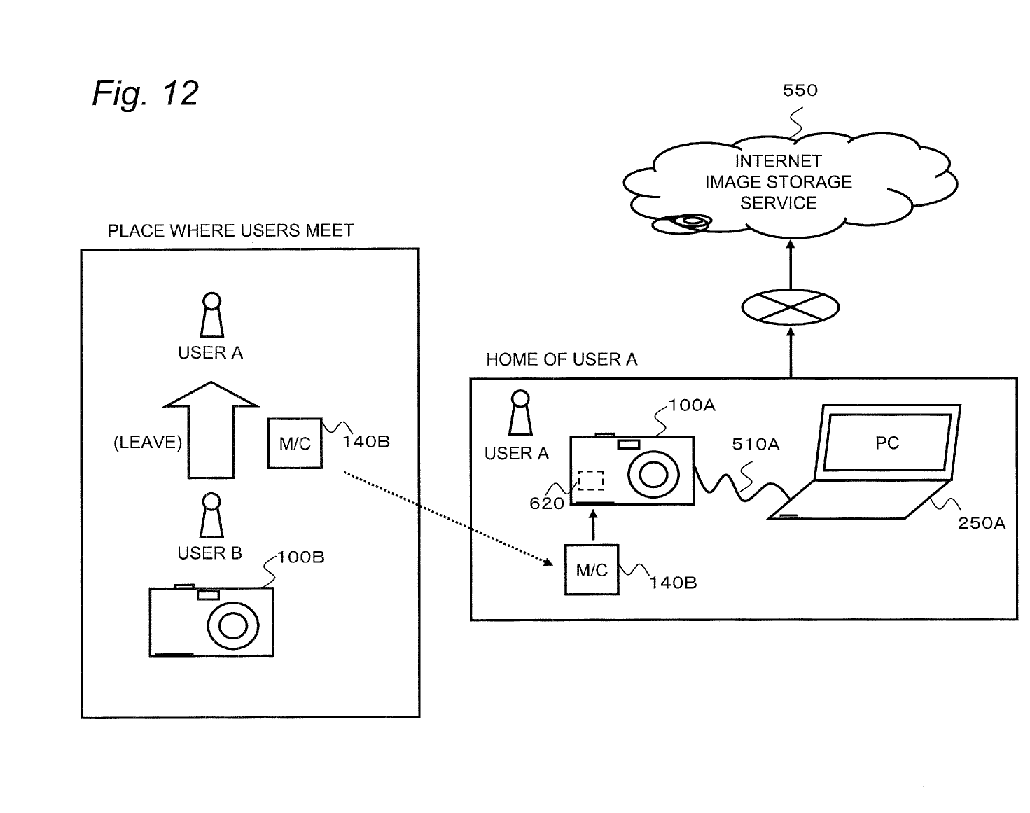

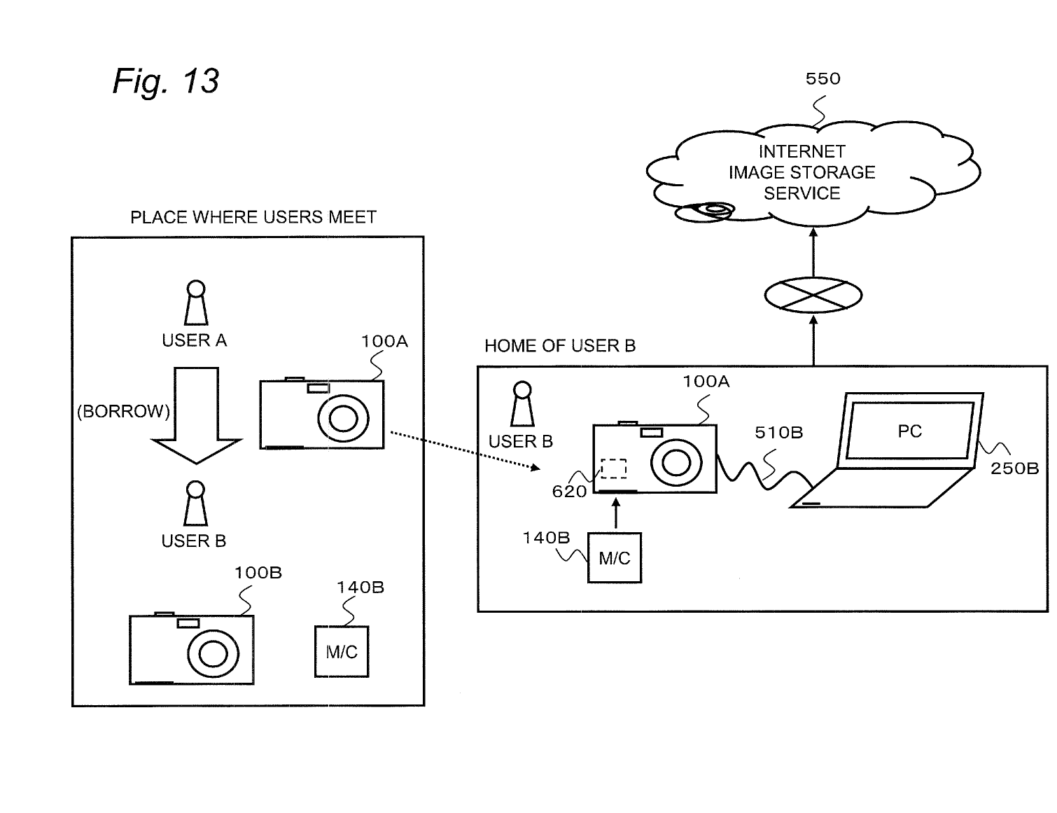

FIG. 12 and FIG. 13 are diagrams describing a use case where the digital camera and the PC are connected by the USB cable to perform upload. In the examples shown in FIG. 12 and FIG. 13, the digital camera 100A owned by the user A has the uploader 620 stored in the flash memory 142 but does not have the function for writing the uploader 620 in the memory card 140B. On the other hand, for the digital camera 100B owned by the user B, a flash memory 142B does not store the uploader 620 and thus the digital camera 100B does not have the function for writing the uploader 620 in the memory card 140B.

The following three use cases are considered as an example where images, that are selected as targets to be uploaded from the images recorded in the memory card 140B owned by the user B, are uploaded onto the server of the image storage service.

### (1) First Use Case

The first use case is a case where the user performs the upload using the PC 250B owned by the user B at home. The digital camera 100B owned by the user B does not store the uploader 620. For this reason, the PC 250B should be installed with the uploader, and thus a troublesome work is required for the user B to carry out the upload.

### (2) Second Use Case

The second use case is a case where, as shown in FIG. 12, the user B gives, to the user A, the memory card 140B storing data to be uploaded and the user A performs the upload using the PC 250A at home. In this case, as shown in FIG. 12, the user B gives, to the user A, the memory card 140B storing data to be uploaded. The user A carries the memory card 140B of the user B back home and carries out the upload. Concretely, the user A inserts the memory card 140B into the card slot of the digital camera 100A. The user A connects the digital camera 100A whose flash memory 142A stores the uploader 620 to the PC 250A via the USE cable 510A. The controller 251A of the PC 250A activates the uploader 620 stored in the flash memory 142A of the digital camera 100A via the USB cable 510A. The PC 250A uploads the images to be uploaded stored in the memory card 140B to the server of the image storage service using the activated uploader 620.

In the above method, although the user B cannot carry out the upload by himself because the user B does not have an electronic device with a upload function, the user A can easily carry out the upload. However, the user B must give the the memory card 140B to the user A at least once, and thus the user B cannot use the memory card 140B while the memory card 140B is with user A, resulting in inconvenience of the user B.

### (3) Third Use Case

The third use case is a case where, as shown in FIG. 13, the user B borrows the digital camera 100A from the user A and the user B carries out the upload using the PC 250B at home.

As shown in FIG. 13, the user B carries the digital camera 100A borrowed from the user A home, and carries out the upload work. Concretely, the user B inserts the memory card 140B to the digital camera 100A borrowed from the user A. The user B connects the digital camera 100A whose flash memory 142A stores the uploader 620 to the PC 250B via the USB cable 510B. The controller 251B of the PC 250B activates the uploader 620 stored in the flash memory 142A of the digital camera 100A via the USB cable 510B. The PC 250B uploads the images to be uploaded stored in the memory card 140B to a server of the image storage service with the activated uploader 620.

In this method, the user B does not have an electronic device with the upload function, but the user B can easily carry out the upload work. However, the user A must give, to the user B, user A's own digital camera 100A at least once, and the user A cannot use the digital camera 100A, while leaving the camera 100A while it is with user B, thus resulting in inconvenience of the user A.

3.2 Case of Transmission with Memory Card

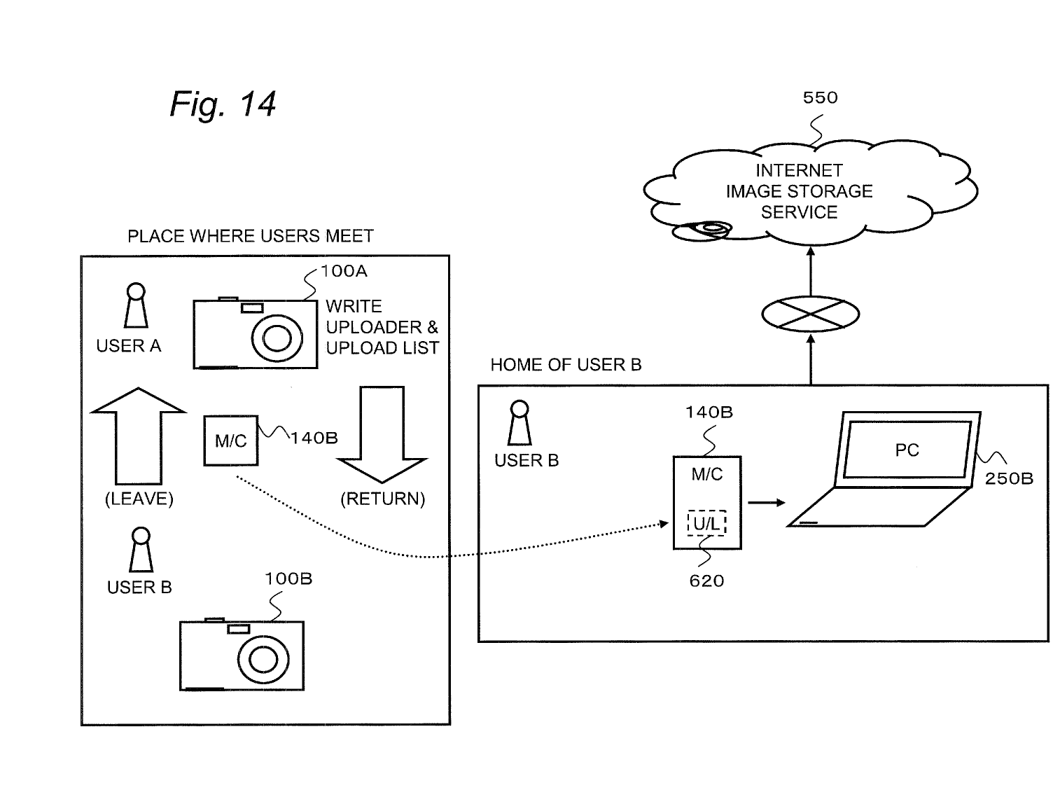

The above-described problems can be solved by storing the uploader 620 in the memory card 140. This is described below with reference to FIG. 14.

FIG. 14 is a diagram describing the use case where the upload function is realized by the uploader stored in the memory card. In the example shown in FIG. 14, the digital camera 100A owned by the user A stores the uploader 620 in the flash memory 142. Further, the digital camera 100A has the function for writing the uploader 620 into a memory card 140B. On the other hand, the digital camera 100B owned by the user B does not have the uploader 620 stored in the flash memory 142B and does not have the function for writing the uploader 620 into the memory card 140B.

Under the above conditions, the user B hands over the memory card 140B to the user A at a certain place. The user A inserts the memory card 140B in the digital camera 100A at the certain place. The user B operates the digital camera 100A to select images to be uploaded. When the selection of the images to be uploaded is completed, a controller 130A of the digital camera 100A writes the uploader 620 as well as the upload list in the memory card 140B. When the writing is completed, the user A takes out the memory card 140B from the digital camera 100A and returns it to the user B.

Thereafter, the user B carries the memory card 140B in which the writing is completed back home, and carries out the upload work. Concretely, the user B inserts the memory card 140B to the PC 250B. The controller 251B of the PC 250B activates the uploader 620 stored in the inserted memory card 140B. The PC 250B uploads the images to be uploaded stored in the memory card 140B to the server of the image storage service according to the upload list with the activated uploader 620.

In this method, although the user B does not have an electronic device having the upload function, the user B can easily carry out the upload work. Further, between the user A and the user B, it does not need to borrow or lend the digital camera and the memory card for a long time. It is enough to borrow or lend the digital camera and the memory card for a short time to record the uploader or the like in the memory card. As a result, the convenience of both the user A and the user is improved.

4. Summary

The digital camera 100 according to the first embodiment includes the card slot 141 that mounts the memory card 140 which stores data, the flash memory 142 that stores the uploader 620 for providing a function of uploading data to the external server via the network, the uploader 620 being software executed by the PC 250, and the controller 130 that records, in the memory card 140, the upload list 610 for specifying data to be uploaded to the external server out of data stored in the memory card 140, and the uploader 620 stored in the flash memory 142.

The digital camera 100 records the uploader 620 and the upload list 610 in the memory card 140. By inserting the memory card 140 in the PC 250, the uploader 620 recorded in the memory card 140 is run so that the upload function can be realized even if the PC 250 does not have the upload function.

### Other Embodiments

The embodiment is not limited to the above embodiment, and various embodiments are considered. Other embodiments are described below.

In the above embodiment, when the memory card 140 is inserted in the PC 250 and the upload list 610 is recorded in the memory card 140, the uploader 620 is automatically activated. However, when the memory card 140 is inserted in the PC 250, regardless of presence/absence of the upload list 610, the controller 251 of the PC 250 may automatically activate the uploader 620.

Further, the digital camera 100 may have a function for setting (selecting) the image storage service as an upload destination. In this case, URL information about the image storage service set by the digital camera 100 is recorded in the memory card 140. At this time, also login information for the set image storage service may be recorded in the memory card 140. In this case, instead of the URL information of the image storage service, it is possible to user other information with which the uploader activated by the PC 250 can identify the site of the image storage service. For example, the uploader sets ID information corresponding to the image storage service with the ID information associated with the URL information. The PC 250 can identify the site of the image storage site which is a destination of upload of image data to be uploaded, based on the ID information recorded in the memory card 140. Alternatively, in a case where it is required to access the predetermined portal site before accessing, from the PC 250, a desired image storage service, the ID information and the image storage service may be related with each other in the portal site. Image data sent together with the ID information from the PC 250 may be uploaded to the image storage service related to the ID information, based on the ID information sent from the PC 250. When the memory card 140 is inserted in the PC 250 and the uploader 620 is automatically activated, the controller 251 of the PC 250 may refer to the information about the image storage service and the login information recorded in the memory card 140 to automatically long in the image storage service.

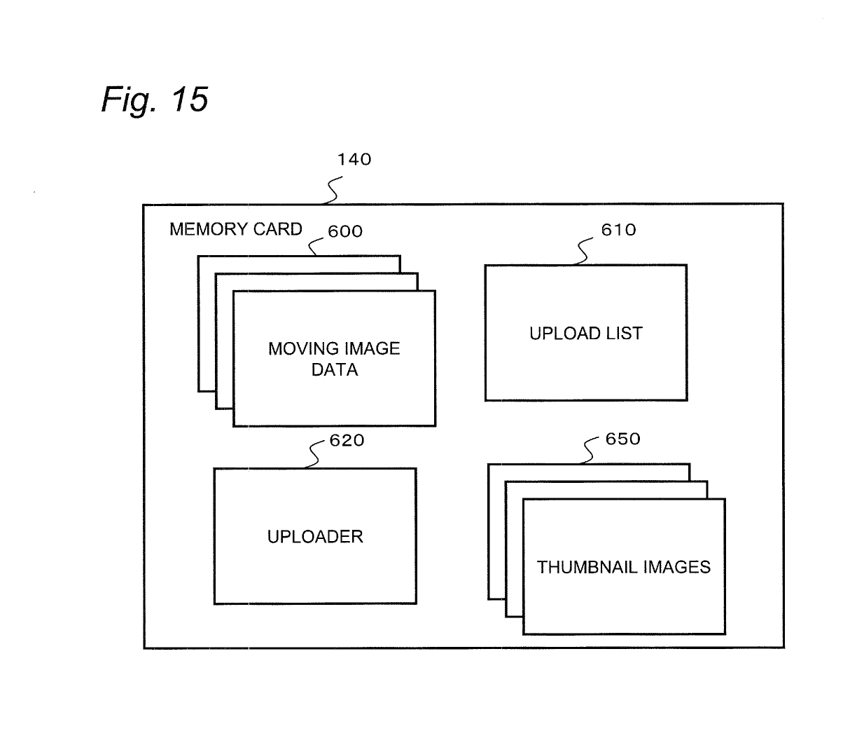

The above embodiment described the case of image data as data to be uploaded, but not limited to this. That is to say, the embodiment can be applied even to audio data and text data. Further, when moving image data is selected as data to be uploaded, as shown in FIG. 15, thumbnail images 650 of representative image of the moving image data may be recorded as well as the upload list (list of image data to be uploaded) 610 and the uploader 620 in the memory card 140. With the thumbnail images 650 recorded in the memory card 140, it can be omitted to generate thumbnails to be displayed on a list screen of images to be uploaded at the activation of the uploader 620.

The above embodiment describe the upload list including the list of image data to be uploaded as one example of information relating to data to be uploaded. The information relating to data to be uploaded is not limited to this. That is to say, any information that can recognize (identify) image data to be uploaded can be used as the information relating to data to be uploaded.

The above embodiment describes the memory card as one example of a removable recording medium of the digital camera 100. The removable recording medium is not limited to this. Another medium which is removable for the digital camera 100, such as a USB memory, and a CD-R can be used.

An idea of the above embodiment can be applied to a lens integrated camera and a lens interchangeable camera.

### INDUSTRIAL APPLICABILITY

The embodiment can be applied to an electronic device such as a digital camera, a movie camera and a mobile phone that can record data to be uploaded, in a recording medium.

What is claimed is:

1. A recording apparatus comprising:
a medium mounting unit operable to mount a removable recording medium which stores data;
a storage unit operable to store an uploader for providing a function of uploading data to an external server via a network, the uploader being software executed by an external apparatus; and
a recording controller operable to record, in the removable recording medium, list information for specifying data to be uploaded to the external server out of data stored in the removable recording medium, and the uploader stored in the storage unit.

2. The recording apparatus according to claim 1, wherein the recording controller records login information for the external server, in the removable recording medium.

3. The recording apparatus according to claim 1, further comprising a selecting unit configured to select data to be uploaded from the data recorded in the removable recording medium.

4. The recording apparatus according to claim 1, wherein
the list information further includes information indicating that upload of data is completed,
the recording apparatus further comprising a display controller operable to display predetermined information indicating that upload is completed on a display device.

5. The recording apparatus according to claim 4, wherein the information indicating that upload is completed is information written by the external apparatus.

6. The recording apparatus according to claim 1, wherein the data is image data.

7. The recording apparatus according to claim 6, wherein the recording controller writes thumbnail information about the image data to be uploaded, in the recording medium.

8. An imaging apparatus comprising:
a medium mounting unit operable to mount a removable recording medium which stores data;
a storage unit operable to store an uploader for providing a function of uploading data to an external server via a network, the uploader being software executed by an external apparatus; and
a recording controller operable to record, in the removable recording medium, list information for specifying data to be uploaded to the external server out of data stored in the removable recording medium, and the uploader stored in the storage unit.

9. The imaging apparatus according to claim 8, wherein the recording controller records login information for the external server, in the removable recording medium.

10. The imaging apparatus according to claim 8, further comprising a selecting unit configured to select data to be uploaded from the data recorded in the removable recording medium.

11. The imaging apparatus according to claim 8, wherein
the list information further includes information indicating that upload of data is completed,
the recording apparatus further comprising a display controller operable to display predetermined information indicating that upload is completed on a display device.

12. The imaging apparatus according to claim 11, wherein the information indicating that upload is completed is information written by the external apparatus.

13. The imaging apparatus according to claim 8, wherein the data is image data.

14. The imaging apparatus according to claim 13, wherein the recording controller writes thumbnail information about the image data to be uploaded, in the recording medium.

15. A recording apparatus comprising:
an interface portion configured to transmit data to a first non-transitory memory;
a controller; and
a second non-transitory memory including an upload program including instructions for configuring an external device to upload data to an external server via a network, the second memory further including instructions for configuring the controller to;
tore in the first memory list information specifying data to be uploaded; and
store in the first memory the upload program for configuring a controller of the external device to upload the data specified by the list information to the external server via the network by executing the instructions of the upload program.

16. An imaging apparatus comprising:
an interface portion configured to transmit data to a first non-transitory memory;
a controller; and
a second non-transitory memory including an upload program including instructions for configuring an external device to upload data to an external server via a network, the second memory further including instructions for configuring the controller to;
store in the first memory list information specifying data to be uploaded; and
store in the first memory the upload program for configuring a controller of the external device to upload the data specified by the list information to the external server via the network by executing the instructions of the upload program.
